(19) United States
(12) Patent Application Publication
(10) Pub. No.: US 2024/0079728 A1
(43) Pub. Date: Mar. 7, 2024

(54) METHODS AND SYSTEMS FOR ENCAPSULATING BATTERY ELECTRODES

(71) Applicant: Preco, LLC, Lenexa, KS (US)

(72) Inventors: Christopher D. Lasnier, Lenexa, KS (US); Percy K. Sagar, Lenexa, KS (US); Paul J. Johnson, Lenexa, KS (US); Zach Haddock, Lenexa, KS (US); Lowell L. Teague, Lenexa, KS (US)

(21) Appl. No.: 18/462,227

(22) Filed: Sep. 6, 2023

Related U.S. Application Data
(60) Provisional application No. 63/403,949, filed on Sep. 6, 2022.

(51) Int. Cl. H01M 50/46; B26F 1/40; B65G 15/58; H01M 4/04; H01M 10/04; H01M 50/406; H01M 50/463

(52) U.S. Cl. CPC H01M 50/46; B26F 1/40; B65G 15/58; H01M 4/043; H01M 4/0471; H01M 10/0404; H01M 50/406; H01M 50/463

(57) ABSTRACT

A system for encapsulating electrodes for a battery includes lower path rollers, a conveyor frame, conveyor drives, a continuous track, and a heat press. The lower path rollers are operable to guide a first web of separator material along a lower web path. The conveyor frame supports the lower path rollers. The conveyor drives are supported on the conveyor frame. The continuous track is driven by the conveyor drives and is positioned beneath the lower web path. The continuous track includes conveyor magnets embedded within pallets. The magnets are operable to secure electrode material against the first web. The heat press is positioned above the continuous track and includes a heated surface configured to heat and press a second web of separator material against the first web to encapsulate at least a portion of the electrode material within the first web and the second web.

### RELATED APPLICATIONS

The present application is a non-provisional application and claims priority benefit of provisional application entitled “ELECTRODE ENCAPSULATION LINE”, Ser. No. 63/403,949, filed on Sep. 6, 2022, the content of which is hereby incorporated in its entirety by reference herein.

### BACKGROUND

Electric vehicles increasingly use pouch-type batteries. Pouch batteries wrap the electrodes (anode and cathode), separator, and electrolyte in a pouch film to create a mono-cell. Multiple mono-cells are then stacked and added to other components to form a battery or battery cell. Electrode production involves cutting electrode materials using a press. The scrap electrode materials must be manually removed from the electrodes to avoid damaging the electrodes. The electrodes are then placed in a stacked arrangement with separator material positioned between the cathode and anode. This process is labor intensive and contains multiple pinch points that reduce efficiency and production rates.

The background discussion is intended to provide information related to the present invention which is not necessarily prior art.

### SUMMARY OF THE INVENTION

The present invention solves the above-described problems and other problems by providing systems and methods for encapsulating electrodes and assembling battery electrodes that enable automation and increased production rates.

A system constructed according to an embodiment of the present invention encapsulates electrodes for a battery. The system includes lower path rollers, a conveyor frame, conveyor drives, a continuous track, and a heat press. The lower path rollers are operable to guide a first web of separator material along a lower web path. The conveyor frame supports the lower path rollers. The conveyor drives are supported on the conveyor frame. The continuous track is driven by the conveyor drives and is positioned beneath the lower web path. The continuous track includes conveyor magnets embedded within pallets. The magnets are operable to secure electrode material against the first web.

The heat press is positioned above the continuous track and includes a heated surface configured to heat and press a second web of separator material against the first web to encapsulate at least a portion of the electrode material within the first web and the second web. The magnets of the continuous track enable the electrode material to be conveyed on separator material. This enables the use of an automated heat press to quickly seal the electrode material in a second web of separator material, thereby producing an electrode capable of integration into a battery, such as a pouch battery.

A method of encapsulating an electrode of a battery includes guiding a first web of separator material onto a magnetic conveyor system. The magnetic conveyor system includes connected pallets forming a continuous track. The pallets have conveyor magnets embedded therein that are operable to secure electrode material against the first web. The method further includes positioning the electrode material onto the first web located on the magnetic conveyor system; guiding a second web of separator material onto the electrode material; shifting, via the magnetic conveyor system, the electrode material positioned between the first web and the second web to a location beneath a heat press; and heating, via the heat press, the first web and the second web around the electrode material, thereby encapsulating the electrode material.

Another embodiment of the present invention is a magnetic conveyor for transporting electrode material of a battery. The magnetic conveyor includes a conveyor frame, conveyor drives, and a continuous track. The conveyor drives are supported on the conveyor frame. The continuous track is driven by the conveyor drives and includes pallets having one or more magnets embedded therein for securing the electrode material in association with the continuous track.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a top plan view of a system for encapsulating an electrode of a battery constructed in accordance with embodiments of the present invention;

FIG. 2 is an exemplary cathode formed by the system of FIG. 1;

FIG. 3 is an exemplary anode formed by the system of FIG. 1;

FIG. 4 is a perspective view of an exemplary receiver operable to receive the electrodes formed by the system of FIG. 1;

FIG. 5 is a side view of a separator material roll unwinder of the system of FIG. 1;

FIG. 6 is a side view of a window forming press and a section of a conveyor frame of the system of FIG. 1 depicting an upper web path and a lower web path;

FIG. 7 is a perspective view of a magnetic conveyor of the system of FIG. 1;

FIG. 8 is a side view of the magnetic conveyor of FIG. 7;

FIG. 9 is a top view of a web, cathode, and anode positioned on the magnetic conveyor of FIG. 7;

FIG. 10 is a perspective view of a continuous track and conveyor drives of the magnetic conveyor of FIG. 7;

FIG. 11 is an exploded view of a pallet of the continuous track of FIG. 10;

FIG. 12 is a perspective view of a cathode cutter of the system of FIG. 1;

FIG. 13 is an elevated perspective view of the cathode cutter of FIG. 12 with top tooling removed to depict two cutting stages of the cathode cutter;

FIG. 14 is a perspective view of a magnetic clamp hitch feed of the cathode cutter of FIG. 12;

FIG. 15 is a sectional view of the magnetic clamp hitch feed of FIG. 14;

FIG. 16 is an elevated perspective view of an anode cutter of the system of FIG. 1 with top tooling removed to depict two cutting stages of the anode cutter;

FIG. 17 is a perspective view of magnetic pick heads of the anode cutter of FIG. 16;

FIG. 18 is a sectional view of the magnetic pick heads of FIG. 17;

FIG. 19 is perspective view of a section of the magnetic conveyor, a heat and seal press, and knockout station of the system of FIG. 1;

FIG. 20 is an elevated perspective view of selected components of the two stages of the cathode cutter of FIG. 12;

FIG. 21 is an elevated perspective view of the selected components of FIG. 20 illustrating the first cutting area;

FIG. 22 is a lowered perspective view of the selected components of FIG. 20 illustrating the upper tools;

FIG. 23 is a block diagram depicting selected components of the system of FIG. 1; and

FIG. 24 is a flowchart depicting exemplary steps of a method according to an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

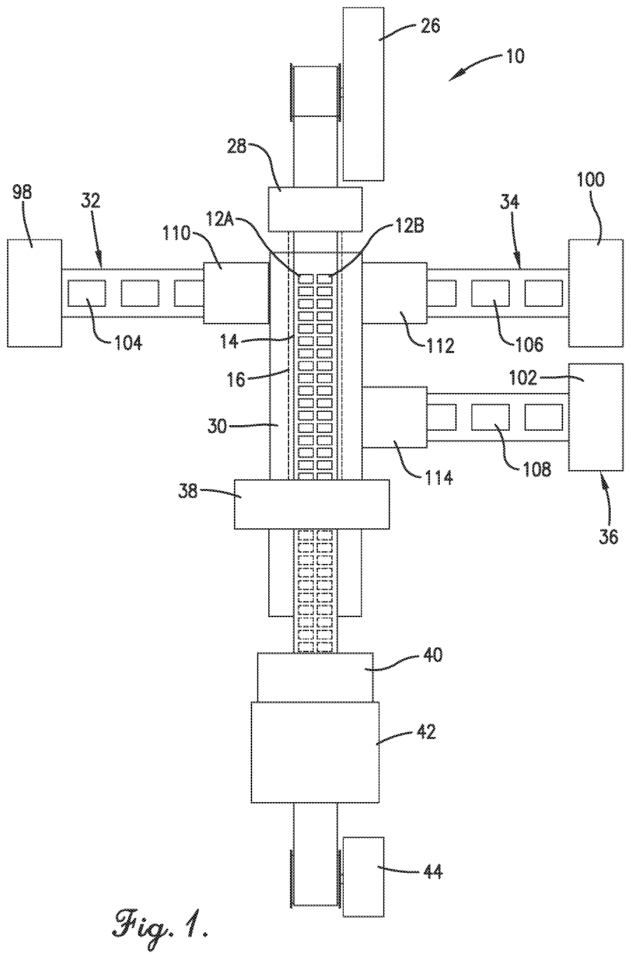

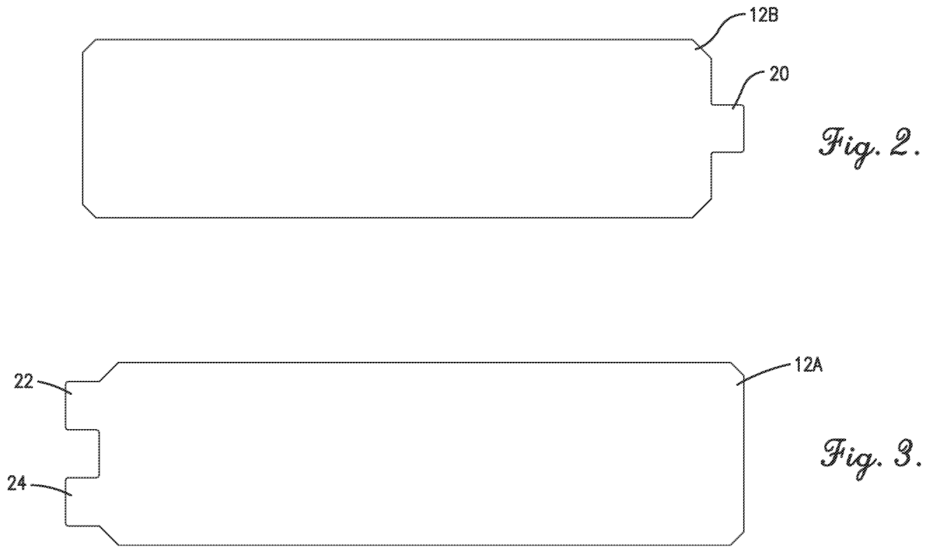

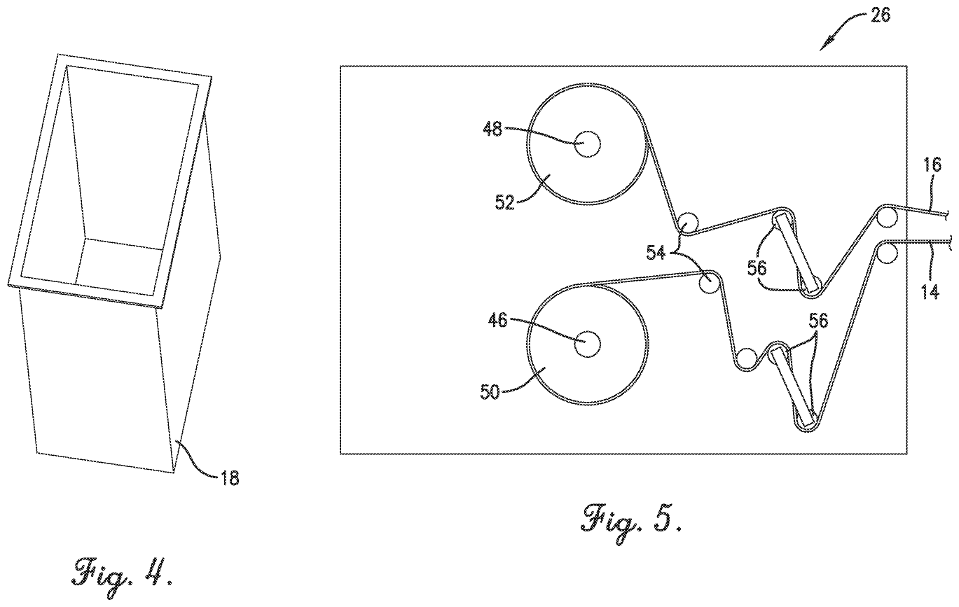

Turning to FIG. 1, a system 10 constructed in accordance with an embodiment of the invention is illustrated. The system 10 is configured to encapsulate electrodes 12A, 12B (anodes 12A and cathodes 12B) with separator material using two webs 14, 16 from one or more rolls of separator material and place the encapsulated electrodes 12A, 12B in a receiver 18 (depicted in FIG. 4). The electrodes 12A, 12B may be made of any type of cathode or anode material known in the art without departing from the scope of the present invention. As shown in FIG. 2, the cathode 12B may include one or more tabs 20. Similarly, as shown in FIG. 3, the anode 12A may also include one or more tabs 22, 24. The tab 20 may be located on the cathode 12B so that it is aligned with the space between the tabs 22, 24 of the anode 12A when the cathode 12B and anode 12A are stacked on top of each other. The separator material may comprise any separator material known in the art for separating cathodes and anodes, such as nonwoven fibers, polymer films, or the like.

Turning back to FIG. 1, an embodiment of the system 10 comprises a separator material unwinder 26, a window press 28, a magnetic conveyor 30, one or more electrode forming systems 32, 34, 36, a heat press 38, a tab forming press 40, a knockout station 42, and a scrap rewind station 44. Turning to FIG. 5, the unwinder 26 comprises one or more rollers 46, 48 for supporting and unwinding rolls 50, 52 of material. The bottom roller 46 supports and/or helps unwind the bottom web 14 from the lower roll of separator material 50. The upper roller 48 supports and/or helps unwind the upper web 16 from the upper roll of separator material 52. In one or more embodiments, the unwinder 26 includes one or more guide rollers 54 and/or tensioner rollers 56 for maintaining the tension in the webs 14, 16.

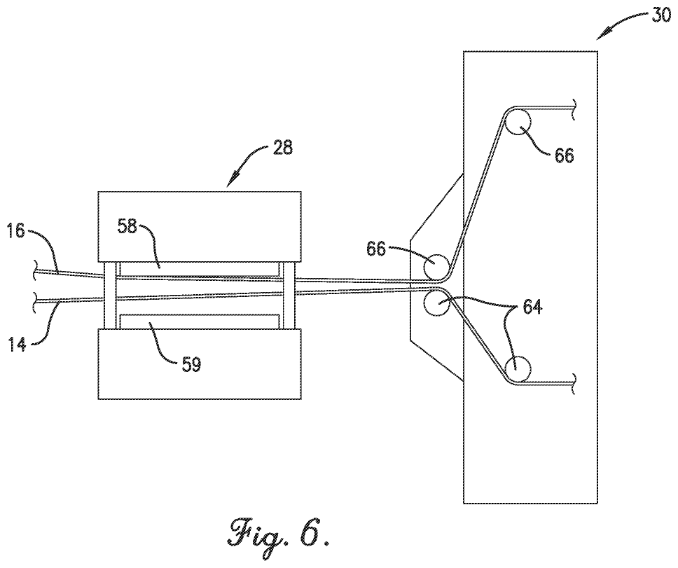

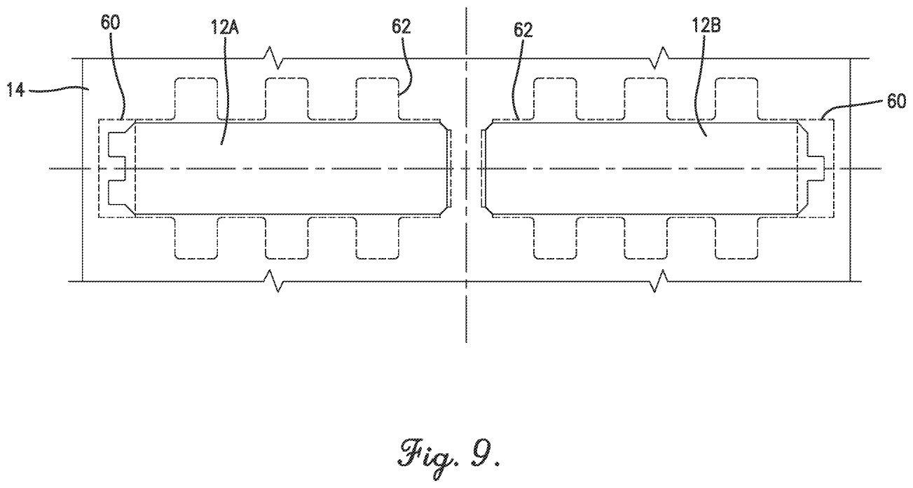

Turning to FIG. 6, the window press 28 receives the webs 14, 16 from the unwinder 26 and is operable to form one or more perforations in the webs 14, 16 in the same action. The press 28 includes one or more cutting tools 58, 59 for forming the perforations. In one or more embodiments, the tools 58, 59 include edges or blades for cutting out windows 60 (depicted as dotted lines in FIG. 9) in the webs 14, 16 corresponding to locations of the tabs 20, 22, 24 when the electrodes 12A, 12B are positioned on the lower web 14. The windows 60 create gaps in the pouch and expose the tabs 20, 22, 24 on the electrodes for connection into a cell later in the manufacturing process.

In one or more embodiments, the tools 58, 59 also include edges or blades for forming perforations representing the outline 62 (also depicted as dotted lines in FIG. 9) of the separator material knocked out with the electrodes 12A, 12B, as discussed in more detail below. The press 28 may be configured to operate so that the upper tool 58 is actuated downwards so that the webs 14, 16 are pressed between the upper tool 58 and lower tool 59, thereby forming the perforations in the webs 14, 16 in the same action, or simultaneously. Once the perforations are formed, one or more lower path rollers 64 direct the perforated lower web 14 along a lower web path to the magnetic conveyor 30, and one or more upper path rollers 66 direct the perforated upper web 16 along an upper web path to the magnetic conveyor 30.

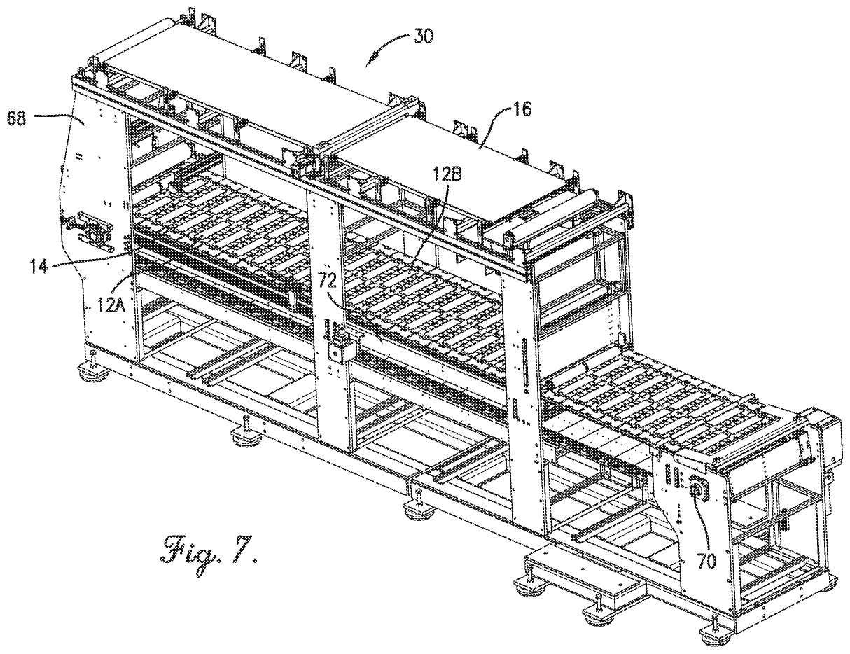

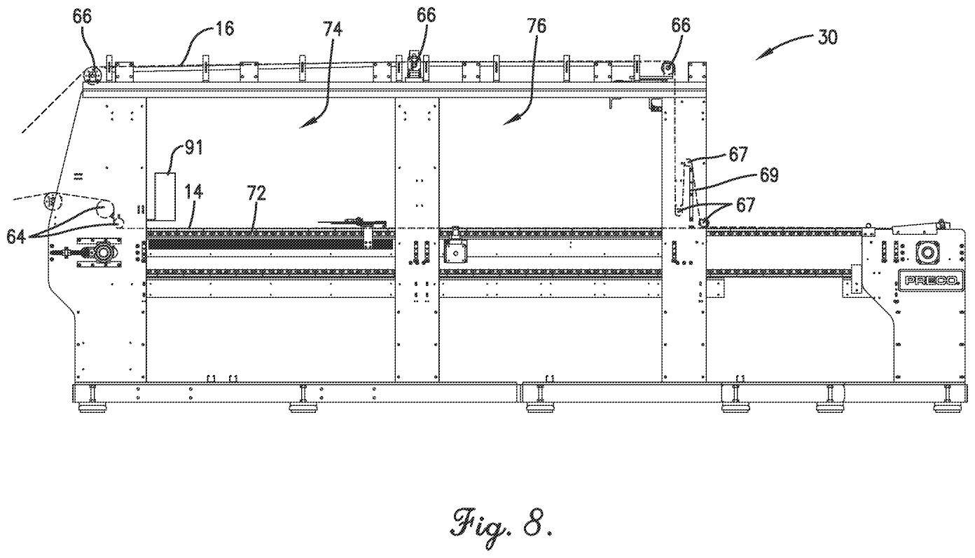

Turning to FIG. 7, the magnetic conveyor 30 helps transport electrodes 12A,B on the lower web 14 to the heat press 38 and then transports the electrodes 12A,B encapsulated in the webs 14, 16 to the tab forming press 40. The conveyor 30 includes a frame 68, one or more conveyor drives 70, and a continuous track 72. The frame 68 may operatively support the conveyor drives 70, the lower path rollers 64, and the upper path rollers 66. Turning to FIG. 8, the lower path rollers 64 define a lower path for the lower web 14 extending along the top of the continuous track 72 so that electrodes 12A,B may be placed directly on the top surface of the lower web 14. The upper path rollers 66 define an upper path above continuous track 72 and spaced apart from the lower path to define electrode material handling spaces 74, 76. Downstream from the electrode material handling spaces 74, 76, one or more of the upper path rollers 66 include phase adjuster rollers 67 that direct the upper web 16 down onto the electrodes 12A, B positioned on the lower web 14 so that the heat press 38 can encapsulate at least portions of the electrodes 12A,B in the webs 14, 16 with the electrodes 12A, B sandwiched between the webs 14, 16. The system 10 may include a vertically actuatable phase adjuster 69 configured to correct any different path length between the upper and lower webs 14, 16. FIG. 9 depicts the electrodes 12A, B positioned on a section of the lower web 14 with the dotted lines representing portions of the webs 14, 16 to be cut and knocked out.

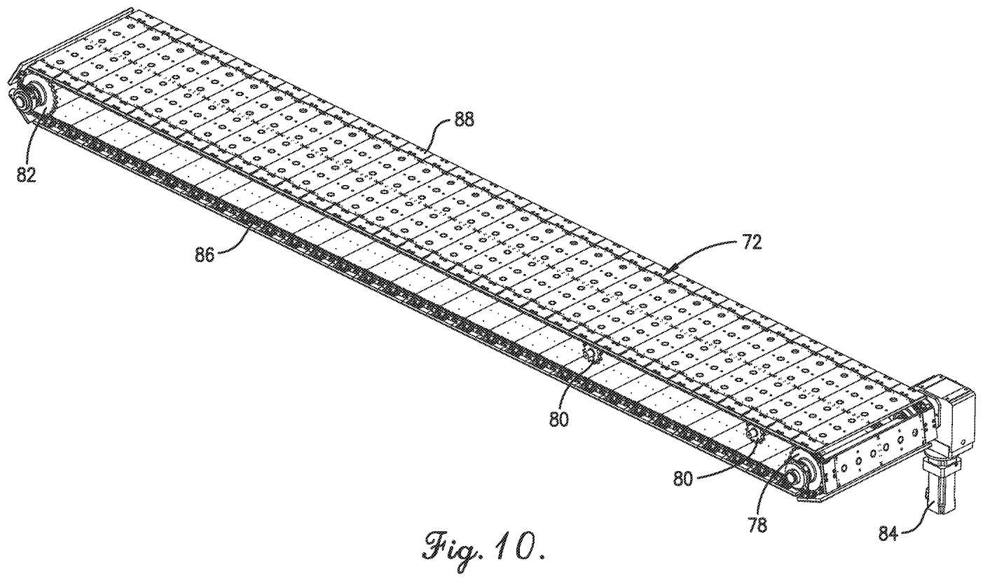

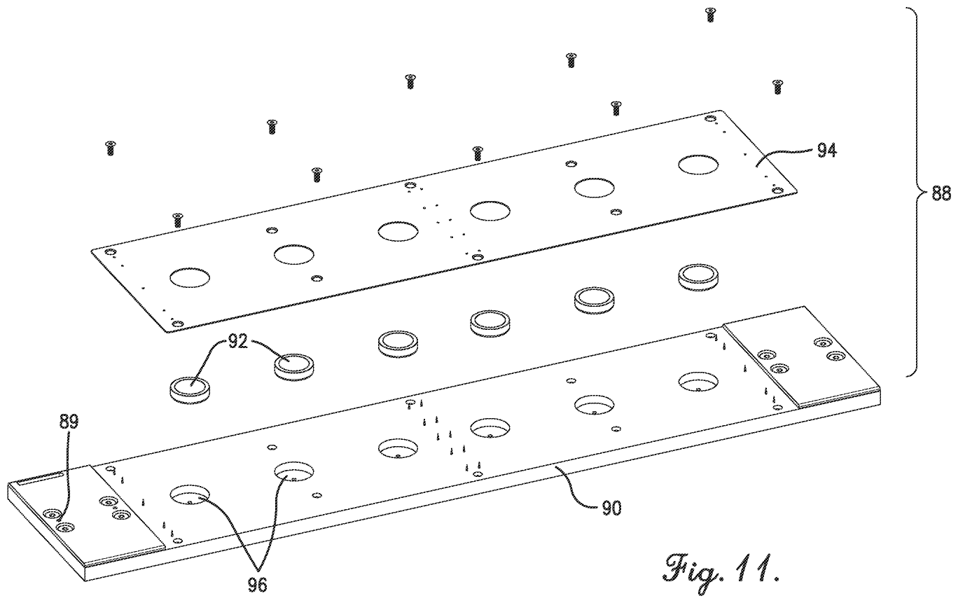

Turning to FIG. 10, the conveyor drives may comprise a drive sprocket 78, one or more support sprockets 80, a guide sprocket 82, and one or more motors 84 for driving the drive sprocket 78. The sprockets 78, 80, 82 may be secured to axles that are rotatably mounted on the conveyor frame via bearings or the like. The sprockets 78, 80, 82 include teeth configured to engage one or more links of the chains (discussed below) of the continuous track 72. The motor 84 may comprise a servo motor that drives the drive sprocket 78, which causes the chains to travel in a continuous path supported by the support and guide sprockets 80, 82.

The continuous track 72 comprises two or more chains 86 and a plurality of pallets 88 connected to the chains 86. As discussed above, the chains 86 are engaged by the sprockets 78, 80, 82 so that the chains 86 rotate about the sprockets 78, 80, 82, thereby shifting the connected pallets 88 with the chains 86. The pallets 88 may be attached to the chains 86 in accordance with a desired center-to-center distance between electrodes 12A, B.

Turning to FIG. 11, an exemplary pallet 88 is depicted and comprises a base 90, a plurality of magnets 92, and a cover 94. The base 90 includes a plurality of cavities 96 for receiving the magnets 92. Embodiments of the invention may include various types of magnets 92 without departing from the scope of the present invention. Such types may include, but are not limited to, permanent magnets such as neodymium iron boron (NdFeB), samarium cobalt (SmCo), alnico, and ferrite or ceramic magnets; temporary magnets such as soft iron magnets; and electromagnets, which can be further subdivided into categories such as iron core, air core, toroidal, and horseshoe electromagnets. In preferred embodiments, the magnets 92 comprise permanent magnets rather than electromagnets as some types of electrode material have insufficient ferrous mass to complete a magnetic field required for an electromagnet to generate a sufficient attractive force to maintain the electrodes on the web 14. Permanent magnets have an intrinsic magnetic field and are capable of producing an attractive force on thin materials that may have limited ferrous material. In such embodiments, the magnets 92 comprise rare-earth magnets, such as NdFeB or SmCo magnets. The magnets 92 are placed in the cavities 96, and the cover 94 is secured to the base 90 to hold the magnets 92 in the base 90.

In one or more embodiments, the pallets 88 include one or more registration marks 89. A sensor, such as a camera 91 (depicted in FIG. 8), may be placed on the conveyor frame 68 for detecting the registrations marks 89 of the pallets 88 to control advancement of the conveyor 30.

Turning briefly back to FIG. 1, the electrode forming systems 32, 34, 36 include one or more material feeds 98, 100, 102 for providing sheets 104, 106, 108 of electrode material to their respective electrode cutting modules 110, 112, 114. The material feeds 98, 100, 102 may include any material handling tools known in the art for providing the sheets 104, 106, 108 to the cutting modules 110, 112, 114, including conveyor systems, cartridges, pinch rollers, etc. The cutting modules 110, 112, 114 are configured to receive their respective sheets 104, 106, 108 and cut from the sheets electrodes 12A, B and then place the electrodes 12A, B onto the conveyor 30 through the electrode material handling spaces 74, 76. While the system 10 is depicted as including one anode forming system 32 and two cathode forming systems 34, 36, the system 10 may include any number or combination of such electrode forming systems without departing from the scope of the present invention. The number of electrode forming systems of a particular type may depend on the type or thickness of material used to form the electrode.

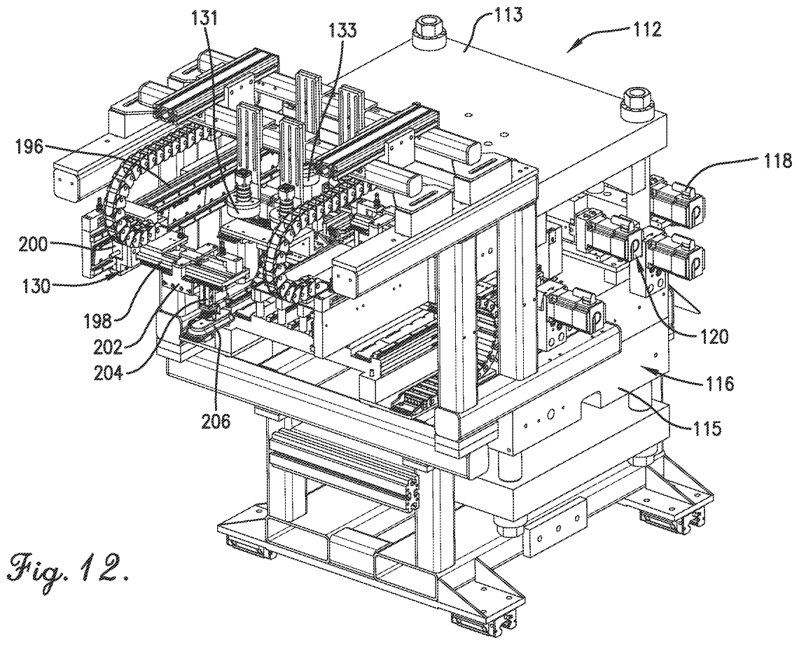

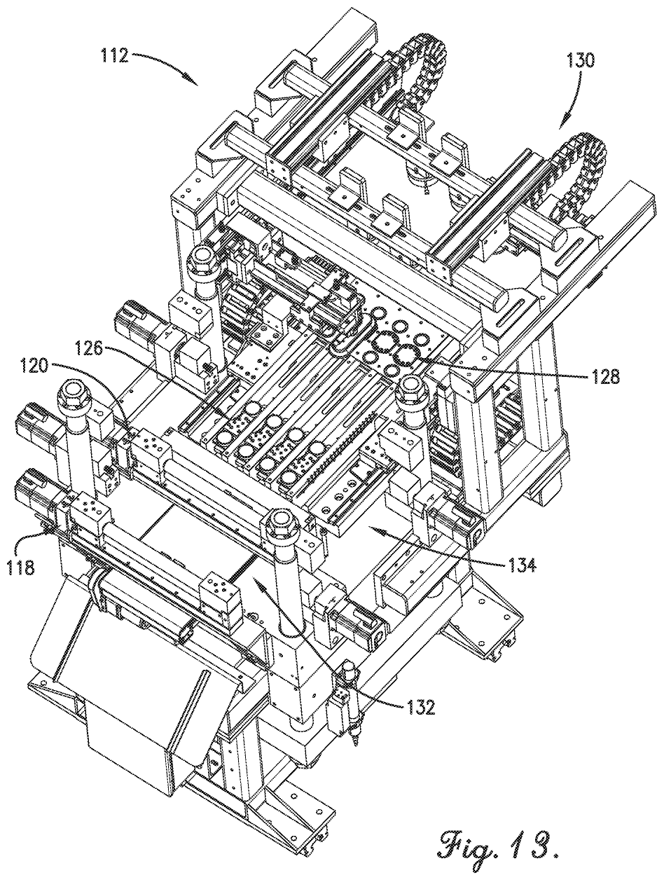

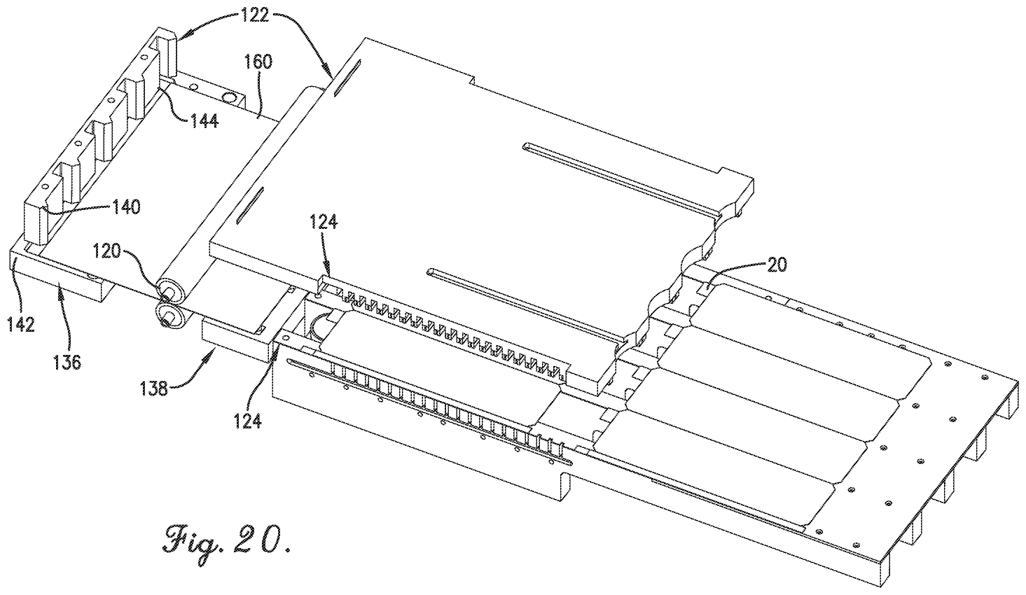

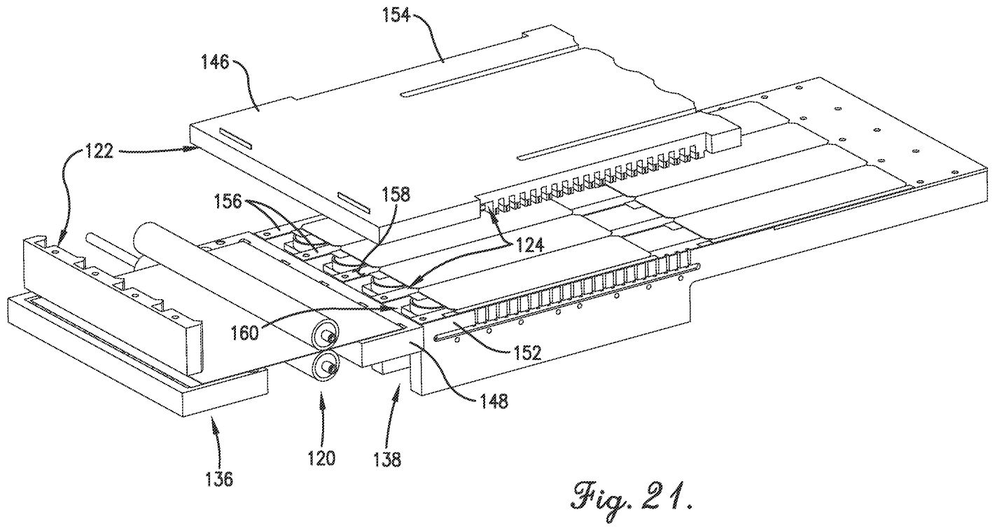

Turning to FIG. 12, an exemplary cathode cutting module 112 is depicted. The cathode cutting module 112 may be substantially similar to the other cathode cutting module 114. The cathode cutting module 112 comprises a frame 116, one or more external feed rollers 118, one or more internal feed rollers 120, a first tool 122 for forming lateral sides of the electrodes (as best depicted in FIGS. 20-22), a second tool 124 for forming longitudinal sides of the electrodes (as depicted in FIGS. 20-22), a magnetic clamp hitch feed 126 (depicted in FIG. 13), a stationary clamp assembly 128 (depicted in FIG. 13), and a pick-and-place assembly 130. The frame 116 is positioned next to the magnetic conveyor 30 and supports the external feed rollers 118, the internal feed rollers 120, the first and second tools 122, 124, the magnetic clamp hitch feed 126, the stationary clamp assembly 128, and the pick-and-place assembly 130.

Turning to FIG. 13, the module 112 is depicted with upper portions of the tools 122, 124 removed to illustrate the two cutting stages of the module 112. The external feed rollers 118 are operable to receive a sheet 106 of cathode material and pull it into a first cutting area 132. The external feed rollers 118 may include a pair of nip or pinch rollers and a motor. Similarly, the internal feed rollers 120 may include a pair of nip or pinch rollers and a motor. The internal feed rollers 120 are operable to receive a portion of the sheet 106 and help position the sheet 106 for the first stage of cutting by the first tool 122 (discussed in more detail below), which forms slits in the sheet 106 that will define the lateral sides of the cathode 12B, including the tabs 20. One end of the sheet 106 may be positioned in the first area 132 and the other end may be positioned in the second cutting area 134 when the lateral sides are being cut. Once the lateral sides of the cathode 12B are formed, the feed rollers 118, 120 cooperatively position the perforated sheet 106 into the second area 134 for cutting the longitudinal sides of the cathode 12B using the second tool 124, as discussed in more detail below.

Turning to FIG. 20, the first and second tools 122, 124 are depicted in isolation from the rest of the module 112. In one or more embodiments, the first tool 122 is a match metal tool with a first punch assembly 136 and a second punch assembly 138. The first punch assembly 136 is positioned on a first side of the internal feed rollers 120, or in the first cutting area 132. In one or more embodiments, the first punch assembly 136 includes an upper tool or punch 140 and a complementary lower die plate 142 that cooperatively form the lateral sides and tabs in the cathodes 12B. The punch 140 includes one or more edges 144 or blades operable to form the tabs 20 in the cathodes 12B.

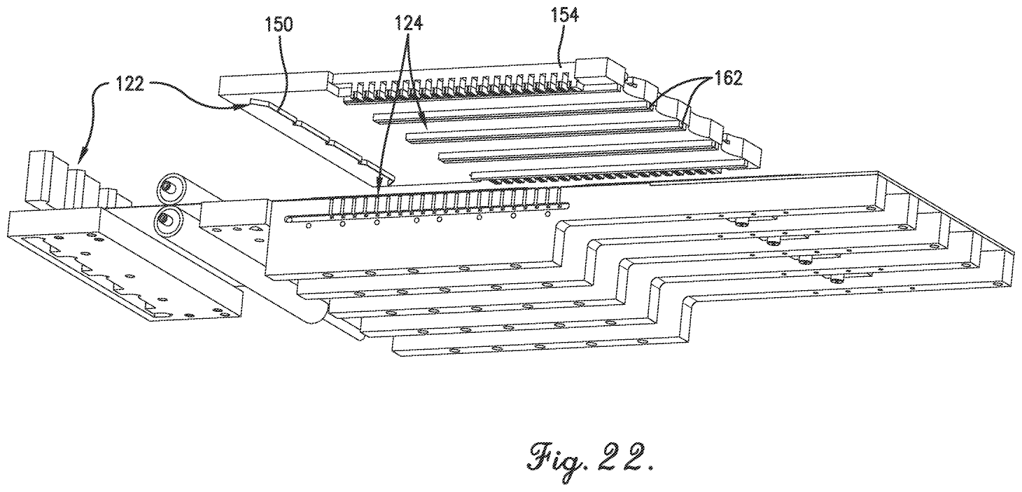

Turning to FIG. 21, the second punch assembly 138 is spaced apart from the first punch assembly 136 and located on a second side of the internal feed rollers 120, or in the second cutting area 134. In one or more embodiments, the second punch assembly 138 includes an upper tool or punch 146 and a complementary lower die plate 148 that cooperatively form the lateral sides in the cathodes 12B opposite the tabs. The upper punch 146 includes one or more punches or knives 150 (depicted in FIG. 22) for cutting the sheet 106 and forming the other lateral sides (or chamfered ends) of the cathodes 12B. The upper punch 146 may be integrally formed with an upper punch of the second tool 124 so that the upper punch 146 of the first tool 122 forms lateral sides in a second sheet while the second tool 124 simultaneously forms longitudinal sides in a first sheet, as depicted in FIG. 21. However, the upper punch 146 may be independent from the second tool 124. Additionally, in one or more embodiments, the first and second assemblies 136, 138 may be positioned on either side of the internal feed rollers 120.

The second tool 124 includes a lower die 152 and an upper punch 154. The lower die 152 includes a plurality of spaced apart steel rule cutting blocks 156. The cutting blocks 156 include cutting surfaces 158 for supporting the perforated sheet of electrode material and against which portions of the upper punch 154 pinch the electrode material to form the longitudinal sides of the cathodes. The cutting blocks 156 are spaced apart from one another to define channels 160. Turning to FIG. 22, the upper punch 154 is positioned above the cutting surfaces 158 and is operable to be actuated to cut the perforated sheet of electrode material against the steel rule cutting surfaces 158 to form the longitudinal sides of the cathodes 12B and thereby cut the cathodes 12B from the sheet 106. The upper punch 154 of the second tool 124 includes cutting edges 162 corresponding to and vertically aligned with the cutting surfaces 158.

The tools 122, 124 may be actuated using any actuator known in the art, including, but not limited to, linear actuators, motors, hydraulic actuators, pneumatic actuators, or the like. As depicted, the module 112 is an underdrive configuration and the ram 113 (depicted in FIG. 12) and therefore the tools 122, 124 are driven up and down by a hydraulic cylinder mounted below the bottom plate 115 of the press. This prevents any hydraulic leaks from contaminating the electrode material. Hydraulic power units for the cathode module 112 may be remotely located in an area away from the module 112. Various adjustments located on the press allow variation of the press tonnage. The down position of the ram 113 may be controlled by powered depth stops, and the up limit of the ram 113 may be programmable from the human-machine interface. The tools 122, 124 may be mounted on linear rails to allow the tools 122, 124 to be positioned correctly relative to the stopping points of the conveyor 30 as a set up variable. One or more clamp brackets may be used to lock the tools 122, 124 to the non-moving portions of the frame 116 once the correct position of the tools 122, 124 has been determined. In one or more embodiments, the tools 122, 124 comprise match metal dies that are punch through dies, thereby enabling the operator to adjust the ram depth for the precise positioning required by the steel rule die 162 cutting against the cutting plate surfaces of the steel rule cutting blocks 156.

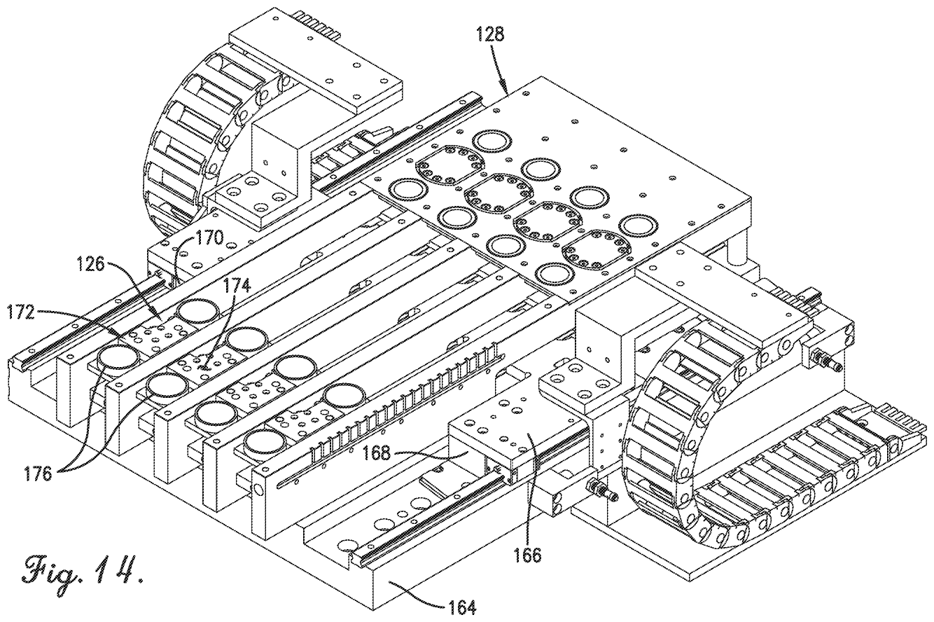

Turning to FIG. 14, once the cathodes 12B are cut from the sheet 106, the magnetic clamp hitch feed 126 shifts the cathodes 12B onto the stationary clamp assembly 128. The magnetic clamp hitch feed 126 includes a track 164, a motor plate 166, actuators 168, 170, and magnetic clamp assemblies 172. The track 164 is supported on the module frame 116, and the motor plate 166 supports the magnetic clamp assemblies 172 and is shiftable along the track 164. The actuators 168, 170 are linear actuators or motors configured to shift the motor plate 166 along the track 164. The magnetic clamp assemblies 172 are shiftable within the channels 160 and comprise a top surface 174 for supporting the cathode sheet/cathodes 12B and one or more clamp magnets 176 for engaging the cathode sheet/cathodes 12B. Similar to the magnets 92 of the conveyor 30, the clamp magnets 176 may include various types of magnets without departing from the scope of the present invention, and in preferred embodiments, comprise rare-earth magnets.

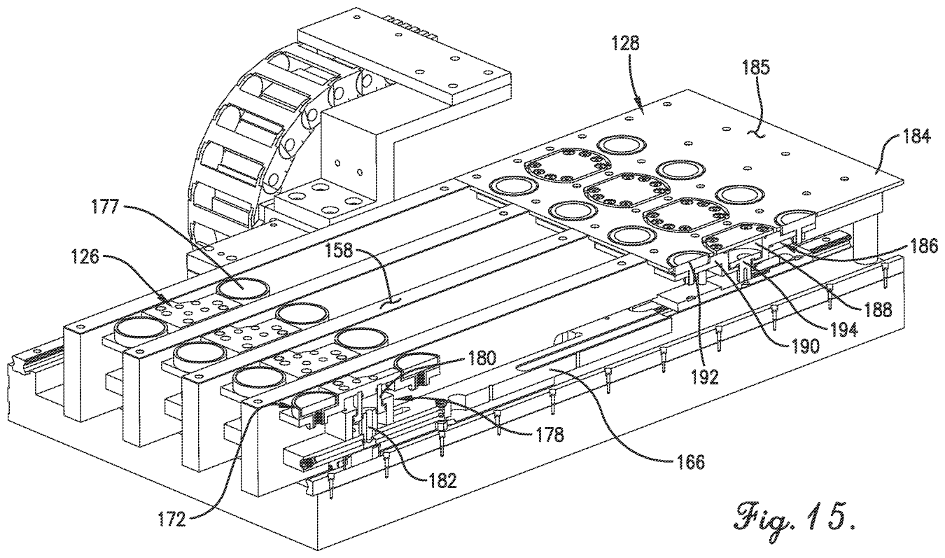

Turning to FIG. 15, the magnetic clamp assemblies 172 are connected to the motor plate 166 via pistons 178. The assemblies 172 may include shiftable rods 180 extending into and shiftable relative to the pistons 178. A pressure source 182 (hydraulic or pneumatic) is operable to shift the rods 180 to shift the assemblies 172 relative to the top surfaces 158 of the cutting blocks. The magnetic clamp assemblies 172 may be configured to be shifted downward below the top surfaces 158 of the cutting blocks to release the hold of the clamp magnets 176 on the cathode sheet/cathodes. Specifically, the magnetic clamp assemblies 172 are operable to engage the perforated sheet of cathode material, hold the sheet until the cathodes 12B are cut from the sheet, shift toward the stationary clamp assembly 128, and shift downwards to release the cathodes 12B onto the stationary clamp assembly 128. While FIG. 15 depicts the magnetic clamp assemblies 172 being shiftable relative to the top surfaces 158 via pistons 178, the assemblies may be shiftable through other means without departing from the scope of the present invention. For example, they may be shiftable via one or more other types of actuators, such linear motors. When the magnetic clamp hitch feed 126 moves the perforated electrode material sheet into position, it simultaneously moves the previous cycle's completed cathodes into the load area by means of the strategically located magnets 177 located on the other side of the top surface 174 of the clamp assemblies relative to magnets 176.

The stationary clamp assembly 128 is positioned between the conveyor 30 and the top surfaces 158 of the cutting blocks. The stationary clamp assembly 128 includes a staging plate 184 and shiftable magnetic clamps 186. The staging plate 184 may be directly or indirectly supported by the module frame. The magnetic clamps 186 are vertically shiftable relative to the top surface 185 of the staging plate 184 and include pistons 188, support plates 190, and one or more staging magnets 192. The pistons 188 are shiftably connected to rods 194 that are in fixed relationships with the module frame and/or the staging plate 184. The support plates 190 are connected to the pistons 188, and the magnets 192 are secured to the support plates 190. The staging plate 184 may include one or more cavities through which at least portions of the staging magnets 192 extend. The stationary clamp assembly 128 receives the cathodes 12B from the magnetic clamp assembly 126, and the staging magnets 192 secure the cathodes 12B until the pick-and-place assembly 130 pulls the cathodes 12B from the staging plate 184 and transports the cathodes to the conveyor 30.

Turning briefly back to FIG. 12, the pick-and-place assembly 130 is configured to engage the cathodes 12B from the stationary clamp assembly 128 and place them on the conveyor 30. The assembly 130 may include one or more tracks 196, 198 along different axes, one or more linear actuators or motors 200, 202, 204, and one or more pick heads 206. The linear actuator 204 shifts the pick head 206 vertically, or along a z-axis, to pick up and release cathodes 12B. The motor 202 shifts the linear actuator 204 and therefore the pick head 206 along the x-axis track 198, and the motor 200 shifts the x-axis track 198 (and therefore the pick head 206) along the y-axis track 196. The pick head 206 may comprise any type of pick head known in the art, including, but not limited to, a vacuum pick head. As depicted in FIG. 12, the pick head 206 comprises a vacuum pick head for use when, for example, the cathode material is non-porous. In one or more embodiments, the pick head 206 may alternatively include a magnetic component, similar to the pick head of the anode module 110 discussed below. The cathode cutting module 112 may further include one or more outboard sensors, such as cameras 131, configured to measure pallet registration mark 89 positions and determine the electrode placement position allowing for a higher placement accuracy than the pallet registration sensor 91 alone. The cathode cutting module 112 may further include one or more inboard sensors, such as cameras 133, configured to view the electrodes in the load position, or on the staging plate 184. Once in the loading area, the inboard cameras 133 determine the precise positions of cathodes, and the outboard cameras 131 determine the precise pallet positions. This allows controllers to determine the required move to place the electrodes correctly on the pallet.

The cathode cutting module 114 may be substantially similar to the cathode cutting module 112. The pick-and-place assembly of the second cathode cutting module 114 is configured to stack its cathodes 12B on top of the cathodes 12B placed on the conveyor 30 by the first cathode cutting module 112. The extra layer of cathode material to form the final cathode product improves the performance of the battery.

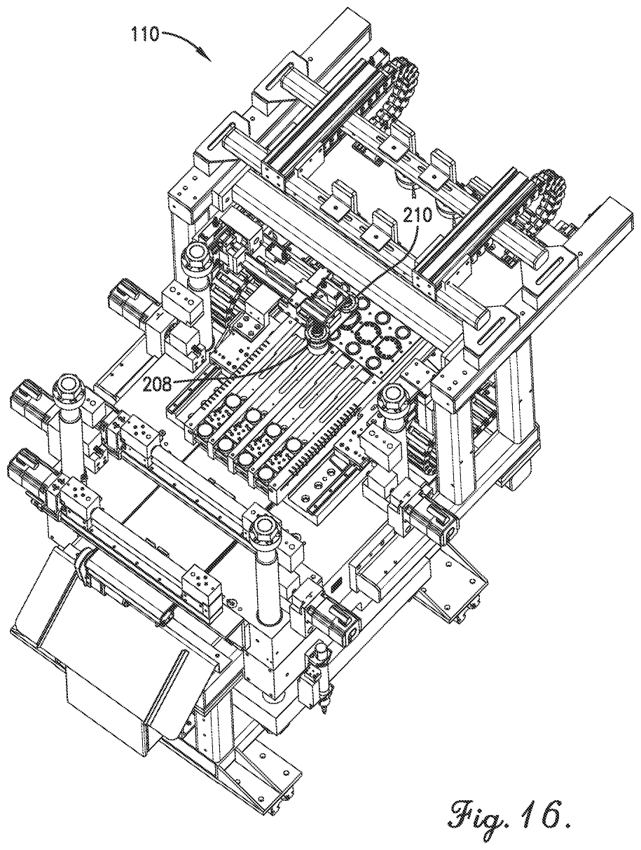

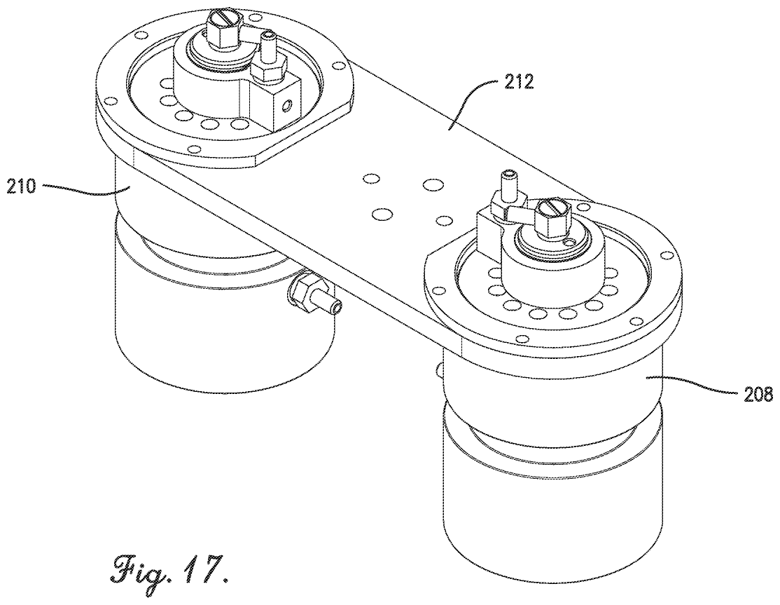

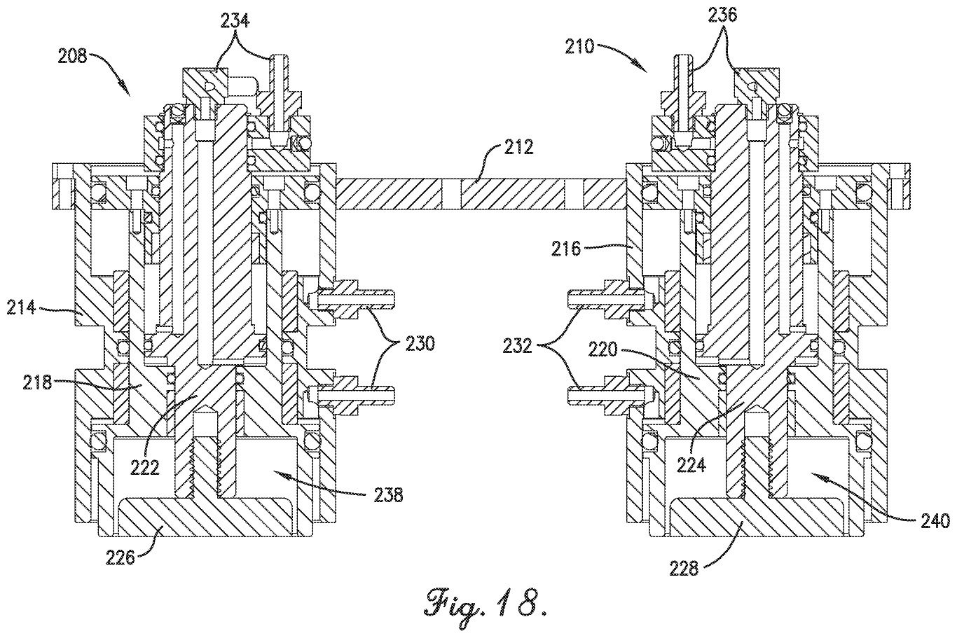

Turning to FIG. 16, the anode cutting module 110 is substantially similar to the cathode cutting module 112 except that the tooling is configured to shape the anodes 12A, and the pick heads 208, 210 include magnets. In one or more embodiments, the anode material comprises several layers of nickel mesh welded together, presenting a thicker, yet porous material. Thus, in one or more embodiments, the tools of the anode cutting module 110 are configured to form the two tabs 22, 24 of the anodes 12A and include a steel rule die to form the notched or chamfered lateral sides of the anodes instead of a match metal die. Further, in one or more embodiments, the magnetic fields of the pick head magnets engage the anodes instead of a vacuum pick head. Turning to FIG. 17, an exemplary pair of anode pick heads 208, 210 are depicted. The pick heads 208, 210 may be secured to the pick-and-place assembly via a support plate 212. Turning to FIG. 18, the pick heads 208, 210 include body cylinders 214, 216, outer pistons 218, 220, inner pistons 222, 224, and pick head magnets 226, 228.

The body cylinders 214, 216 are operatively associated with the actuator via the support plate 212. The support plate 212 may be sized to hold the pick heads 208, 210 at a distance to prevent them from coinciding with the magnets on the pallets of the conveyor. The outer pistons 218, 220 are positioned in the body cylinders 214, 216 and are operable to shift relative to the body cylinders 214, 216 due to pressure differentials applied at the outer piston air sources 230, 232. The outer pistons 218, 220 define chambers within which the inner pistons 222, 224 shift. The inner pistons 222, 224 are positioned in the chambers and are operable to shift relative to their respective outer pistons 218, 220 due to pressure differentials applied at the inner piston air sources 234, 236. While the pick heads 208, 210 are described as being pneumatic, they may alternatively be hydraulic or electrically actuated without departing from the scope of the present invention. The pick head magnets 226, 228 are attached to the inner pistons 222, 224 are operable to magnetically attract the anodes 12A and hold the anodes 12A when in the extended position depicted in FIG. 18. When the pick heads 208, 210 are positioned over the lower web 14 on the conveyor 30, the inner pistons 222, 224 are configured to retract the pick head magnets 226, 228 into the magnet chambers 238, 240 defined by the outer pistons 218, 220. The top surfaces of the anodes 12A then abut the bottom ends of the outer pistons 218, 220, while the inner pistons 222, 224 pull the magnets 226, 228 away from the anodes 12A. The anodes 12A are distanced from the magnetic field of the magnets 226, 228, thereby reducing the attractive forces and releasing the anodes 12A onto the lower web 14 on the conveyor 30.

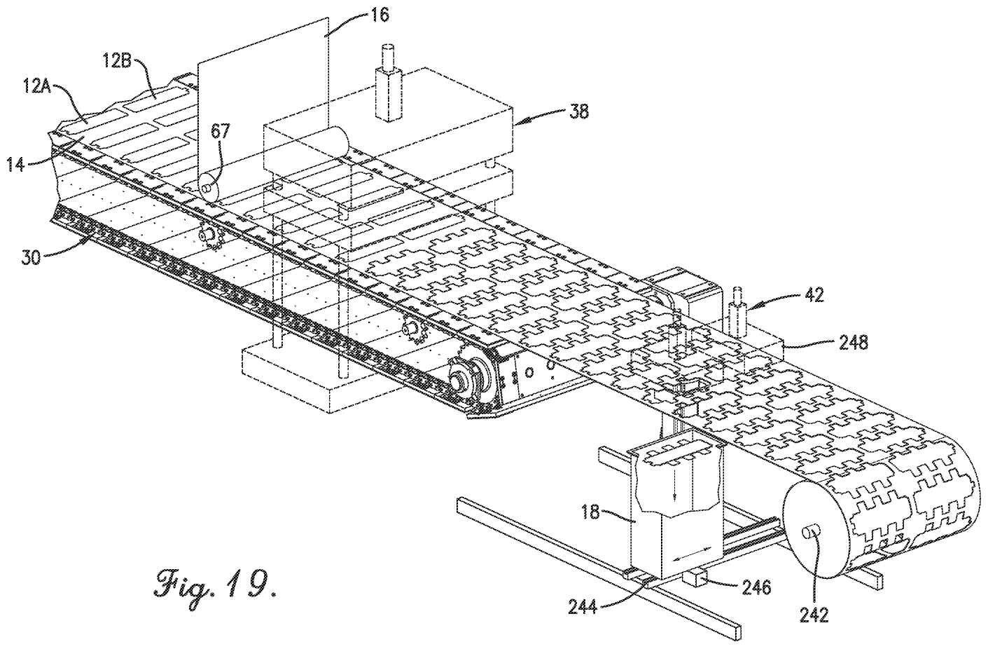

Turning to FIG. 19, once the electrodes 12A, B have been placed on the lower web 14 on the conveyor 30, the phase adjuster rollers 67 direct the upper web 16 down onto the electrodes 12A, B. The heat press 38 applies a heated edge or surface around the electrodes 12A, B (the dotted lines in FIG. 9) thereby encapsulating at least a portion of the electrodes 12A, B in the webs 14, 16. The heat press 38 may also include one or more cutting edges for forming perforations in the webs 14, 16 around the electrodes 12A, B to aid in removing the encapsulated electrodes from the webs 14, 16. The tab forming press 40 is a vertically-actuating press with protrusions positioned to contact and bend the tabs of the electrodes to predefined angles relative to the remainder of their electrode bodies. The scrap rewind station 44 includes one or more scrap rollers 242 that help pull the webs 14, 16 with the electrodes 12A, B encapsulated therein off the magnetic conveyor 30 toward the knockout station 42. The receiver 18 is movably positioned on a track 244 and shifted by an actuator 246, such as a servo motor. The knockout station 42 includes a punch 248 that is actuated to push out one of the electrodes 12A, B at a time while the actuator 246 shifts the receiver 18 to receive the knocked-out electrode. The receiver 18 is actuated back and forth along the track 244 so that it alternates between receiving anodes 12A and cathodes 12B. This results in the anodes 12A and cathodes 12B being stacked in an alternating order within the receiver 18. The scrap roller 242 winds up the scrap separator material of the webs 14, 16.

While the system 10 is described as being configured to produce both anodes 12A and cathodes 12B, the system 10 may be configured to produce only one type of electrode without departing from the scope of the present invention. For example, the cathode forming systems 34, 36 may replace the anode forming system 32 or vice versa, and the knockout station 42 may place the knocked-out electrodes of a single type in a container for offline installation in a battery or on a conveyor system.

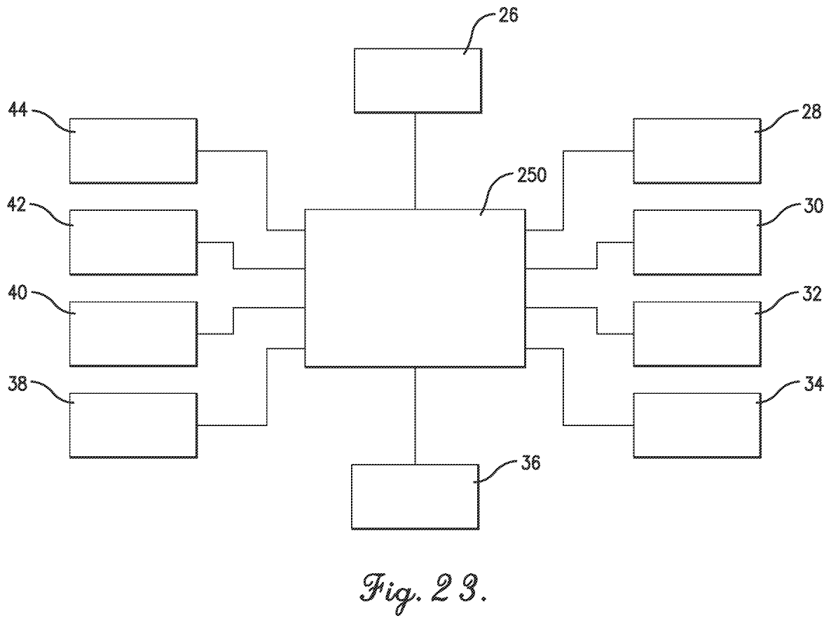

Turning to FIG. 23, an exemplary control architecture of the system 10 is depicted. The system 10 may include one or more controller 250 in wired or wireless communication with the motor controllers, sensors, valves, and pumps of the separator material unwinder 26, the window press 28, the magnetic conveyor 30, the electrode forming systems 32, 34, 36, the heat press 38, the tab forming press 40, the knockout station 42, and the scrap rewind station 44. Various components of the system 10 may be controlled by and/or in communication with the controller 250. The controller 250 may comprise a communication element, a memory element, a human-machine interface, and one or more processing element. The communication element may generally allow communication with systems or devices within and/or external to the system 10. The communication element may include signal or data transmitting and receiving circuits, such as antennas, amplifiers, filters, mixers, oscillators, digital signal processors (DSPs), and the like. The communication element may establish communication wirelessly by utilizing RF signals and/or data that comply with communication standards such as cellular 2G, 3G, 4G, 5G, or LTE, WiFi, WiMAX, Bluetooth®, BLE, or combinations thereof. The communication element may be in communication with the processing element and the memory element.

The memory element may include data storage components, such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element may be embedded in, or packaged in the same package as, the processing element. The memory element may include, or may constitute, a “computer-readable medium”. The memory element may store the instructions, code, code segments, software, firmware, programs, applications, apps, services, daemons, or the like that are executed by the processing element.

The user interface generally allows the user to utilize inputs and outputs to interact with the system 10 and is in communication with the processing element. Inputs may include buttons, pushbuttons, knobs, jog dials, shuttle dials, directional pads, multidirectional buttons, switches, keypads, keyboards, mice, joysticks, microphones, or the like, or combinations thereof. The outputs of the present invention may include a display or any number of additional outputs, such as audio speakers, lights, dials, meters, printers, or the like, or combinations thereof, without departing from the scope of the present invention.

The processing element may include processors, microprocessors (single-core and multi-core), microcontrollers, DSPs, field-programmable gate arrays (FPGAs), analog and/or digital application-specific integrated circuits (ASICs), or the like, or combinations thereof. The processing element may generally execute, process, or run instructions, code, code segments, software, firmware, programs, applications, apps, processes, services, daemons, or the like. The processing element may also include hardware components such as finite-state machines, sequential and combinational logic, and other electronic circuits that can perform the functions necessary for the operation of the current invention. The processing element may be in communication with the other electronic components through serial or parallel links that include address buses, data buses, control lines, and the like.

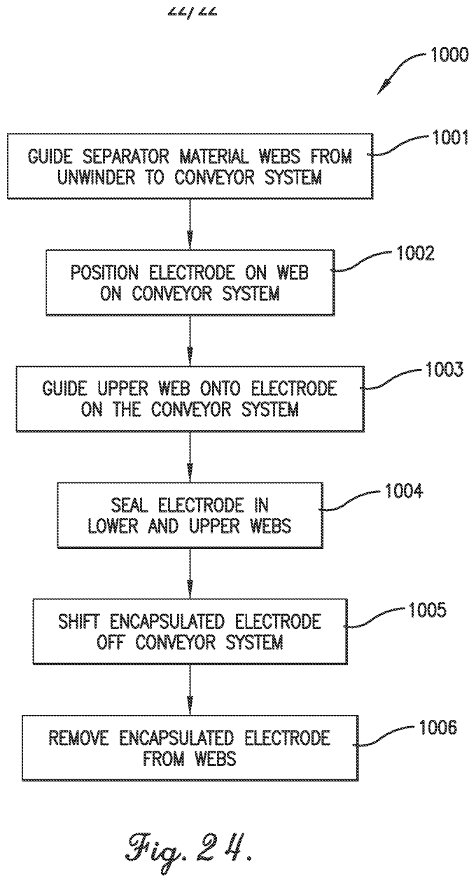

The flow chart of FIG. 24 depicts the steps of an exemplary method 1000 of encapsulating one or more electrode of a battery. In some alternative implementations, the functions noted in the various blocks may occur out of the order depicted in FIG. 24. For example, two blocks shown in succession in FIG. 24 may in fact be executed substantially concurrently, or the blocks may sometimes be executed in the reverse order depending upon the functionality involved. In addition, some steps may be optional.

The method 1000 is described below, for ease of reference, as being executed by exemplary devices and components introduced with the embodiments illustrated in FIGS. 1-23. The steps of the method 1000 may be performed by the controller 250 through the utilization of processors, transceivers, hardware, software, firmware, or combinations thereof. However, some of such actions may be distributed differently among such devices or other devices without departing from the spirit of the present invention. Control of the system may also be partially implemented with computer programs stored on one or more computer-readable medium(s). The computer-readable medium(s) may include one or more executable programs stored thereon, wherein the program(s) instruct one or more processing elements to perform all or certain of the steps outlined herein. The program(s) stored on the computer-readable medium(s) may instruct processing element(s) to perform additional, fewer, or alternative actions, including those discussed elsewhere herein.

Referring to step 1001, the first and second webs are unwound from rolls of separator material and guided to the conveyor. In one or more embodiments, this step also includes forming tab windows and/or perforations in the webs via the window press. The second web may be directed along an upper web path on the conveyor system at a distance from the first web to define an electrode handling space.

Referring to step 1002, one or more electrodes are positioned on the lower web on the conveyor. In one or more embodiments, only one type of electrode is placed on the conveyor from one or both sides of the conveyor. In other embodiments, the anodes are placed on the conveyor from a first side of the conveyor, and the cathodes are placed on the conveyor from a second side of the conveyor. The material feeds provide sheets of electrode material to their respective electrode cutting modules. The cutting modules receive their respective sheets and cut from the sheets electrodes and place the electrodes onto the conveyor through the electrode handling space.

The external feed rollers receive a sheet of electrode material and pull it into a first cutting area. The internal feed rollers receive a portion of the sheet and help position the sheet for the first stage of cutting by the first tool, which forms slits in the sheet that will define the lateral sides of the electrode, including any tabs. One end of the sheet is positioned in the first area and the other end is positioned in the second cutting area when the lateral sides are being cut. Once the lateral sides of the electrode are formed, the feed rollers cooperatively position the perforated sheet into the second area for cutting the longitudinal sides of the electrode using the second tool, as discussed in more detail below.

In one or more embodiments, depending on the type of electrode material, the first tool is a match metal tool with a first punch assembly and a second punch assembly. However, in one or more embodiments, such as for embodiments forming anodes from thicker material, the second punch assembly includes a steel rule die. The first punch assembly is positioned on a first side of the internal feed rollers, and when the press actuator actuates the ram, the ram causes the punch of the first assembly to shift toward the complementary lower die plate to cooperatively form the lateral sides and tabs in the electrodes. Meanwhile, the second punch assembly, which is spaced apart from the first punch assembly and located on a second side of the internal feed rollers, is pushed by the ram so that its punch is actuated toward its complementary lower die plate to cooperatively form the lateral sides in the electrodes opposite the tabs. The actuation of the ram also causes the second tool to be actuated so that its upper punch shifts toward the steel rule cutting surfaces to form the longitudinal sides of the electrodes in a sheet that had previously been cut by the first tool.

Once the electrodes are cut from the sheet, the magnetic clamp hitch feed shifts the electrodes toward the stationary clamp assembly and the pistons are actuated to retract the magnets below the surfaces of the cutting blocks to release the electrodes. When the magnetic clamp hitch feed moves the perforated electrode material sheet into position, it simultaneously moves the previous cycle's completed electrodes into the load area or onto the staging plate by the magnets proximal to the staging plate. The stationary clamp assembly receives the electrodes from the magnetic clamp assembly, and the staging magnets secure the electrodes until the pick-and-place assembly pulls the electrodes from the staging plate and transports the electrodes to the conveyor.

The pick-and-place assembly engages the electrodes from the stationary clamp assembly and places them on the conveyor. This step may include measuring pallet registration mark positions, via the outboard cameras, and determining, via the controller, the electrode placement position allowing for a higher placement accuracy than the pallet registration sensor alone. This step may further include determining the precise positions of electrodes via the inboard cameras, and determining, via the controller, the required move to place the electrodes correctly on the pallet.

In one or more embodiments in which the electrode material is porous or otherwise unable to be picked up by a vacuum pick head and is magnet, the electrode material is picked up using the pick head magnets. The pick head magnets magnetically attract the electrodes and hold the electrodes when in the extended position. When the pick heads are positioned over the lower web on the conveyor, the inner pistons retract the pick head magnets into the magnet chambers so that the top surfaces of the electrodes abut the bottom ends of the outer pistons. The inner pistons pull the magnets away from the electrodes so that the electrodes are distanced from the magnetic field of the magnets, thereby reducing the attractive forces and releasing the electrodes onto the lower web on the conveyor.

Referring to step 1003, the upper web is guided onto the electrodes located on the lower web. This step may include correcting, via the phase adjuster, any different path length between the upper and lower webs. This includes directing, via the conveyor, the upper and lower webs with the electrodes encapsulated inside the webs to positions beneath the heat press.

Referring to step 1004, the electrodes are sealed, via the heat press, in the upper and lower webs. This includes actuating the heated surface of the heat press towards the upper web so that it contacts the top surface of the upper web around the perimeter of the electrode and presses the upper web. The heated surface causes the upper web to partially melt and bond with the lower web around the electrode. In one or more embodiments, this step includes forming one or more slits or perforations in the webs around the perimeter of the electrode.

Referring to step 1005, the encapsulated electrode is shifted, via guide rollers, off the conveyor. The tension of the webs induced by the rollers along with movement of the webs pulls the electrodes outside the grip of the magnets of the conveyor. The webs may be directed at least in part via the scrap roller.

Referring to step 1006, the electrode encapsulated within portions of the webs is removed from the rest of the webs via the knockout station. This step includes actuating a punch toward the webs and punching the encapsulated electrode out of the web. In one or more embodiments, this step includes positioning the receiver, via the actuator, and catching the electrode in the receiver. This step may also include repositioning the receiver, via the actuator, and catching in the receiver an electrode of an opposite type punched from the web.

The method 1000 may include additional, less, or alternate steps and/or device(s), including those discussed elsewhere herein.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth in any subsequent regular utility patent application. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim (s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for encapsulating electrodes for a battery, the system comprising:
lower path rollers operable to guide a first web of separator material along a lower web path;
a conveyor frame supporting one or more of the lower path rollers;
one or more conveyor drives supported on the conveyor frame;
a continuous track driven by the one or more conveyor drives and positioned beneath the lower web path, the continuous track comprising a plurality of pallets having one or more conveyor magnets embedded therein operable to secure electrode material against portions of the first web on the lower web path; and
a heat press positioned above the continuous track and including one or more heated surface configured to heat and press a second web of separator material against the first web to encapsulate at least a portion of the electrode material within the first web and the second web.

2. The system of claim 1, further comprising upper path rollers operable to guide the second web along an upper web path that is at a distance above the lower web path to define an electrode material handling space.

3. The system of claim 2, further comprising phase adjuster rollers supported on the conveyor frame and operable to guide the second web onto the electrode material positioned on the first web on the continuous track.

4. The system of claim 3, further comprising one or more scrap rollers positioned on a side of the heat press where the first web and the second web exit the heat press, the one or more scrap rollers being operable to engage portions of the first web and the second web and guide the portions of the first web and the second web off the continuous track.

5. The system of claim 3, further comprising:
a tab window forming press positioned upstream of the upper path rollers and operable to receive the first web and the second web and including a cutting tool operable to cut one or more window in the first web and the second web with the first web and the second web stacked together in the cutting tool; and
an image-capturing device positioned on the heat press and configured to capture image data of the first web and the second web to determine that the windows of the first web and the second web are registered with the tabs of the electrode material.

6. The system of claim 1, further comprising:
an electrode material pick head configured to temporarily engage electrode material; and
an electrode actuator configured to shift the electrode material pick head toward the first web.

7. The system of claim 6, wherein the electrode material pick head comprises:
a body cylinder operatively associated with the electrode actuator;
an outer piston positioned in the body cylinder and operable to shift relative to the body cylinder and comprising a chamber;
an inner piston positioned in the chamber and operable to shift relative to the outer piston; and
a pick head magnet attached to the inner piston.

8. The system of claim 6, further comprising:
a match metal tool operable to receive a sheet of electrode material and form perforations in the sheet of electrode material that define lateral sides of the electrode material;
two or more metal cutting surfaces for receiving the perforated sheet of electrode material, the two or more metal surfaces spaced apart from one another to define a channel therebetween;
a cutting tool positioned above the two or more metal cutting surfaces and operable to be actuated to cut the perforated sheet of electrode material against the two or more metal cutting surfaces to form the electrode material;
a magnetic clamp assembly shiftable within the channel comprising one or more clamp magnets for engaging the electrode material; and
an actuator configured to shift the magnetic clamp assembly within the channel.

9. The system of claim 8, further comprising an internal nip roller operable to pull the perforated sheet of electrode material toward the two or more metal cutting surfaces.

10. The system of claim 9, wherein the match metal tool comprises:
a first punch assembly including edges operable to form one or more tabs in the electrode material positioned on a first side of the nip roller; and
a second punch assembly spaced apart from the first punch assembly and operable to form a side of the electrode material opposite the one or more tabs positioned on a second side of the nip roller opposite to the first side.

11. The system of claim 8, wherein the magnetic clamp assembly comprises one or more clamp pistons configured to shift the one or more clamp magnets relative to the two or more metal cutting surfaces.

12. The system of claim 8, further comprising a stationary clamp assembly positioned between the continuous track and the two or more metal cutting surfaces, the stationary clamp assembly including a staging plate for receiving the electrode material from the magnetic clamp assembly and one or more staging magnets embedded in the staging plate operable to secure the electrode material to the staging plate until the electrode material pick head pulls the electrode material from the staging plate and transports the electrode material to the continuous track.

13. The system of claim 12, further comprising one or more staging pistons configured to shift the staging plate relative to the one or more staging magnets embedded in the staging plate to release the electrode material.

14. The system of claim 12, wherein the one or more conveyor magnets, the one or more clamp magnets, and the one or more staging magnets comprise permanent magnets.

15. A method of encapsulating an electrode of a battery, the method comprising:
guiding a first web of separator material onto a magnetic conveyor system, the magnetic conveyor system comprising a plurality of connected pallets forming a continuous track, the pallets having one or more conveyor magnets embedded therein and operable to secure electrode material against portions of the first web;
positioning the electrode material onto a portion of the first web located on the magnetic conveyor system;
guiding a second web of separator material onto the electrode material;
shifting, via the magnetic conveyor system, the electrode material positioned between the first web and the second web to a location beneath a heat press; and
heating, via the heat press, at a least a portion of the first web and the second web around the electrode material, thereby encapsulating at a portion of the electrode material.

16. The method of claim 15, further comprising:
forming perforations in a sheet of electrode material, the perforations defining lateral sides of the electrode material with one or more tabs;
shifting the perforated sheet onto two or more spaced apart metal cutting surfaces that define a channel therebetween;
cutting the perforated sheet along the two or more cutting surfaces to form the electrode;
shifting the electrode, via a magnetic clamp assembly, to a staging platform; and
positioning the electrode, via a pick-and-place machine, onto the magnetic conveyor system.

17. The method of claim 16, wherein the perforated sheet is shifted onto the two or more spaced apart metal cutting surfaces via a nip roller.

18. A magnetic conveyor for transporting electrode material of a battery, the magnetic conveyor comprising:
a conveyor frame;
one or more conveyor drives supported on the conveyor frame; and
a continuous track driven by the one or more conveyor drives, the continuous track comprising a plurality of pallets having one or more magnets embedded therein for securing the electrode material in association with the continuous track.

19. The magnetic conveyor of claim 18, wherein the one or more magnets comprise permanent magnets.

20. The magnetic conveyor of claim 18, further comprising:
lower path rollers rotatably supported on the conveyor frame and operable to guide a first web of separator material along a lower web path on the continuous track so that the electrode material is secured to the continuous track on top of the first web;
upper path rollers rotatably supported on the conveyor frame and operable to guide a second web along an upper web path that is at a distance above the lower web path to define an electrode material handling space;
phase adjuster rollers rotatably supported on the conveyor frame and operable to guide the second web from the upper web path down onto the electrode material on the first web; and
a camera supported by the conveyor frame and configured to capture image data of the first web and the second web.
